(19) United States
(12) Patent Application Publication
(10) Pub. No.: US 2018/0060563 A1
(43) Pub. Date: Mar. 1, 2018

(54) SEMICONDUCTOR DEVICE, DATA PROCESSING DEVICE, AND AUTHENTICATION METHOD

(71) Applicant: RENESAS ELECTRONICS CORPORATION, Tokyo (JP)

(72) Inventors: Kazuo TASHIRO, Tokyo (JP); Makoto TOYOSHIMA, Tokyo (JP); Kentaro OMATA, Tokyo (JP); Tsukasa YOBO, Tokyo (JP)

(21) Appl. No.: 15/685,886

(22) Filed: Aug. 24, 2017

(30) Foreign Application Priority Data
Aug. 25, 2016 (JP) 2016-164452

(51) Int. Cl. G06F 21/44; H04L 9/32; H04L 9/08; H04L 9/06

(52) U.S. Cl. CPC G06F 21/44; H04L 9/3278; G06F 2221/2129; H04L 9/0643; H04L 9/0866

(57) ABSTRACT

Even when specific information (first information, second information) about individual sensors is inadequate to identify each of the individual sensors, whether all the sensors coupled to a semiconductor device are authentic can be determined. The semiconductor device can be electrically coupled with plural sensors and is configured as follows. Registration information is generated based on first combined information composed of plural combined pieces of first specific information respectively about plural sensors coupled to the semiconductor device when making registration. The semiconductor device generates determination target information based on second combined information composed of plural pieces of second specific information respectively about plural sensors coupled to the semiconductor device when making determination and compares the determination target information with the registration information. When the comparison result is a non-match, it is determined that not all the sensors coupled to the semiconductor device are authentic and in normal condition.

### CROSS-REFERENCE TO RELATED APPLICATIONS

The disclosure of Japanese Patent Application No. 2016-164452 filed on Aug. 25, 2016 including the specification, drawings and abstract is incorporated herein by reference in its entirety.

### BACKGROUND

The present invention relates to a semiconductor device, a data processing device, and an authentication method, particularly, an authentication method suitably usable in a system configured including a semiconductor device or a data processing device to determine authenticity of plural sensors coupled to the system.

With IoT (Internet of Things) spreading, the number of sensors coupled to various networks has been explosively increasing. In this situation, the importance of security technology usable for sensor authentication performed to eliminate fake (inauthentic) sensors has been increasing.

In Japanese Unexamined Patent Application Publication No. 2012-33593, a method of determining whether electronic circuit parts are authentic parts manufactured by qualified manufacturers is disclosed. According to the method, when electronic circuit parts are manufactured, the manufactured electronic circuit parts are made to operate under predetermined conditions and, during the operation, the waveforms of power consumption or electromagnetic waves of the electronic circuit parts are measured and are stored as waveform data. When the authenticity of the electronic circuit parts is to be determined, the electronic circuit parts are made to operate under the same conditions as the conditions applied to the electronic circuit parts when made to operate after manufacture and the waveforms newly measured are compared with the stored waveforms.

### SUMMARY

As a result of studying Japanese Unexamined Patent Application Publication No. 2012-33593, the present inventors have found the following problem.

To accurately determine the authenticity of electronic circuit parts according to the authentication method disclosed in Japanese Unexamined Patent Application Publication No. 2012-33593, the waveforms outputted from the authentic electronic circuit parts are required to distinctively differ from the waveforms outputted from inauthentic electronic circuit parts. This requires the respective waveforms to carry information enough to identify individual electronic circuit parts.

For example, IEEE 1451.4 Transducer Electronic Data Sheet (TEDS) carry such basic information as manufacturer names, model numbers, and serial numbers as Basic TEDS. The IEEE (The Institute of Electrical and Electronic Engineers) of the USA provides various standardization standards including the IEEE 1451.4 Standard. The IEEE 1451.4 Standard is aimed at saving initial setting work when various sensors are coupled to, for example, IoT networks. The amount of information provided by the Basic TEDS is considered enough to identify individual parts and is therefore considered usable for authentication of electronic circuit parts as described above.

However, making individual electronic parts such as sensors respectively carry amounts of information enough to identify the individual parts is not realistic considering practical limitation, for example, with respect to cost.

Hence, an authentication method applicable to electronic parts not having such information for individual part identification is required.

Means for achieving the above object will be described in the following. Other objects and novel features of the present invention will become apparent from the description of this specification and the attached drawings.

An embodiment of the present invention is as follows.

The semiconductor device according to the embodiment can be electrically coupled with plural sensors and is configured as follows.

Registration information is generated based on first combined information composed of plural combined pieces of first specific information respectively about plural sensors coupled to the semiconductor device when making registration. The registration information may be generated either by the semiconductor device or outside the semiconductor device.

The semiconductor device generates determination target information based on second combined information composed of plural pieces of second specific information respectively about plural sensors coupled to the semiconductor device when making determination and compares the determination target information with the registration information. When the result of the comparison is a non-match, it is determined that not all the sensors coupled to the semiconductor device are authentic and in normal condition.

The advantageous effects of the above embodiment are briefly described below.

Even in cases where specific information (first information, second information) about individual sensors is inadequate to identify each of the individual sensors, the sensors coupled to the semiconductor device as a whole can be identified, so that whether all the sensors are authentic and in normal condition can be determined. In information comparison made for sensor authentication, a non-match can occur when at least an authentic sensor has been replaced by an inauthentic sensor and also when at least an authentic sensor is out of order.

### BRIEF DESCRIPTION OF THE DRAWINGS

FIG. 1 is a block diagram schematically showing an example configuration of a semiconductor device according to an embodiment of the present invention.

FIG. 2 is a block diagram schematically showing the theory of a sensor authentication method.

FIG. 3 is a block diagram showing an example hardware configuration of a semiconductor device according to an embodiment of the present invention.

FIG. 4 is a block diagram schematically showing an example configuration of a data processing device according to an embodiment of the present invention.

FIG. 5 is a flowchart showing an example of processing for initially registering sensor information in a semiconductor device or data processing device.

FIG. 6 is a flowchart showing an example of sensor authentication processing performed in a semiconductor device or data processing device.

FIG. 7 is a flowchart showing an example of processing performed in a semiconductor device or data processing device after addition or replacement of a sensor.

FIG. 8 is a block diagram schematically showing an example configuration of a semiconductor device according to another embodiment of the present invention.

### DETAILED DESCRIPTION

Embodiments of the present invention will be described in detail in the following. In all drawings referred to in describing the embodiments, elements having identical functions will be denoted by identical symbols and descriptive duplication will be avoided.

### First Embodiment

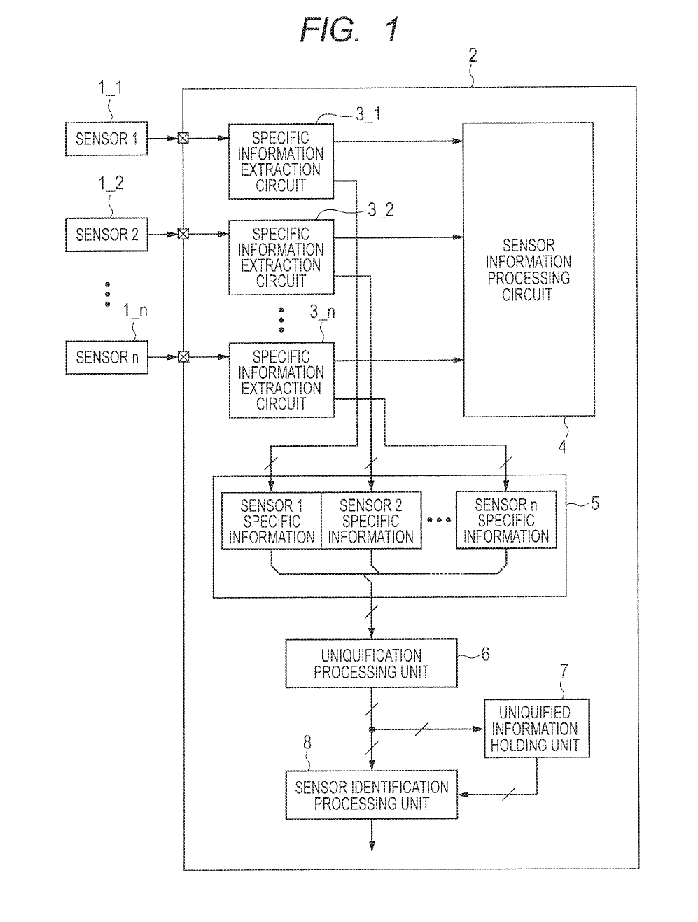

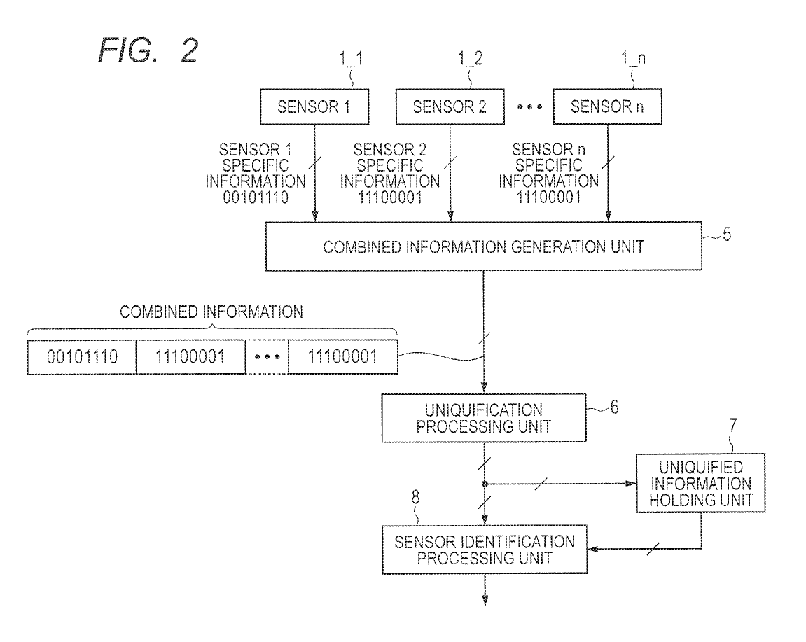

FIG. 1 is a block diagram schematically showing an example configuration of a semiconductor device according to an embodiment of the present invention. FIG. 2 is a block diagram schematically showing the theory of a sensor authentication method.

A semiconductor device 2 shown in FIG. 1 can be electrically coupled with plural sensors 1_1 to 1_n and can determine whether all the sensors are authentic and in normal condition.

The theory of the sensor authentication method illustrated in FIG. 2 will be described first.

Specific information about respective sensors 1_1 to 1_n is inputted to a combined information generation unit 5. The combined information generation unit 5 generates combined information by combining the received specific information and supplies the generated combined information to a uniquification processing unit 6. The uniquification processing unit 6 generates uniquified information based on the received combined information.

First, the combined information generation unit 5 generates combined information by combining specific information about plural sensors 1_1 to 1_n that has been obtained in an initial state where all the sensors have been ensured to be authentic and operating in normal condition, then the uniquification processing unit 6 generates uniquified information corresponding to the generated combined information and stores the uniquified information in a uniquified information holding unit 7. This process will be referred to as “registration” and the information stored in the uniquified information holding unit 7 will be referred to as “registration information.” Also, the time at which the process for registration is carried out will be referred to as the “time of registration.”

Subsequently, authentication is carried out on sensors 1_1 to 1_n as required. When carrying out the authentication, specific information about respective sensors 1_1 to 1_n coupled to the semiconductor device 2 is read in. The combined information generation unit 5 generates combined information by combining the specific information and supplies the combined information to the uniquification processing unit 6. The uniquification processing unit 6 then generates uniquified information corresponding to the combined information and supplies the uniquified information to a sensor identification processing unit 8. The uniquified information generated at this time will be referred to as “determination target information.” The sensor identification processing unit 8 compares the determination target information with the registration information stored in the uniquified information holding unit 7. When the result of the comparison is a non-match, it is determined that not all the sensors coupled to the semiconductor device 2 at the time of the determination are authentic and in normal condition. When, on the other hand, the result of the comparison is a match, it is determined that all the sensors 1_1 to 1_n coupled to the semiconductor device 2 are authentic and operating in normal condition.

In this way, even when the amount of specific information about individual sensors 1_1 to 1_n is inadequate to identify each of the individual sensors 1_1 to 1_n, the sensors coupled to the semiconductor device 2 as a whole can be identified, so that whether all the sensors are authentic and in normal condition can be determined. For example, when the specific information about each of the sensors 1_1 to 1_n is composed of 8 bits, only up to 256 different sensors can be identified. When, by combining eight pieces of such specific information, 64-bit combined information is generated and is made usable for identification purposes, the combined information can be used to determine whether the sensors currently coupled to the semiconductor device 2 are authentic.

When not all the sensors are authentic and in normal condition, at least one of the sensors is inauthentic, i.e. fake, or possibly out of order.

Reverting to FIG. 1, an example configuration of the semiconductor device 2 capable of sensor authentication as described above is schematically shown. The semiconductor device 2 includes specific information extraction circuits 3_1 to 3_n, a sensor information processing circuit 4, the combined information generation unit 5, the uniquification processing unit 6, and the uniquified information holding unit 7. The signals from the sensors 1_1 to 1_n may either be analog or digital. The specific information extraction circuits 3_1 to 3_n extract from the signals inputted from the sensors 1_1 to 1_n, the respective specific information and supplies the extracted specific information to the combined information generation unit 5, while also supplying the sensor-sensed information to the sensor information processing circuit 4. For example, in cases where the signals from the sensors are analog signals superimposed with modulated specific information, the specific information extraction circuits 3_1 to 3_n extract the specific information by demodulating the modulated specific information. Alternatively, in cases where the signals from the sensors are received as packets based on a predetermined rule, the specific information is extracted, following the predetermined rule, from the sensor-sensed information.

The combined information generation unit 5 generates combined information by combining the received specific information about the sensors 1_1 to 1_n and supplies the generated combined information to the uniquification processing unit 6. The combined information may be the specific information about the sensors 1_1 to 1_n simply serially coupled or rearranged, after being subdivided, based on an appropriate rule.

The uniquification processing unit 6 generates uniquified information from the combined information. The uniquified information is preferably generated by irreversibly compressing the specific information. Compression reduces the amount of information (number of bits), so that the scale of the subsequent-stage circuit can be made smaller. Also, when software is to be subsequently used, variables of shorter word lengths can be used, so that the number of software execution steps can be reduced. Furthermore, since the compression is irreversible, even if uniquified information is leaked, the specific information about sensors cannot be exposed. An example of irreversible compression is a hash function. A hash function is characterized in that its original data before compression cannot be forged, so that data security is enhanced. Another example of irreversible compression is a MAC (Message Authentication Code) or it may be a HMAC (Hash-based Message Authentication Code). Though it has been stated above that the uniquified information is preferably generated by irreversibly compressing the specific information, an alternative method may also be used. For example, the uniquified information may be generated by encrypting the combined information using an encryption circuit provided in the uniquification processing unit 6. In this case, too, even when the encrypted uniquified information is leaked, the specification information about sensors cannot be exposed.

Also, the combined information may be used as is as the uniquified information without involving irreversible compression processing by the uniquification processing unit 6. This will be described later as a third embodiment.

The uniquified information that is generated from the specific information about the sensors 1_1 to 1_n coupled to the semiconductor device 2 at the time of registration is stored as the registration information in the uniquified information holding unit 7, and the determination target information that is the uniquified information generated from the sensors 1_1 to 1_n coupled to the semiconductor device 2 at the time of determination is compared with the registration information stored in the uniquified information holding unit 7. When the result of the comparison is a match, all the sensors 1_1 to 1_n are determined to be authentic and operation of the sensor information processing circuit 4 is continued. When the comparison result is a non-match, it is determined that at least one of the sensors 1_1 to 1_n coupled to the semiconductor device 2 is either inauthentic or out of order to be incapable of obtaining correct specific information. In this case, operation of the sensor information processing circuit 4 is stopped.

The specific information obtained from sensors 1_1 to 1_n is, for example, trimming data used to compensate for sensor variations caused in manufacture. Inauthentic sensors cannot pass as authentic sensors unless the inauthentic sensors are identical with the authentic sensors in terms of variations caused in manufacture. An inauthentic sensor having the same trimming data as that of an authentic sensor may pass as the authentic sensor. However, sensor authentication is made by comparison based on combined information, so that, even though the number of bits of trimming data for each sensor is small, a high level of security can be ensured for sensors 1_1 to 1_n as a whole. The specific information obtained from each of the sensors 1_1 to 1_n may also be ID (identification) information held by the sensor or a PUF (Physical Unclonable Function) as specific data based on variations in manufacture of transistors making up a memory cell of an SRAM (Static Random Access Memory).

As described above, compared with cases in which sensors are individually authenticated, authentication based on combined sensor information involves a larger amount of information with increased uniqueness. Hence, a larger number of sensors included in a same system leads to a higher rate of inauthentic sensor detection and higher detection accuracy.

### Second Embodiment

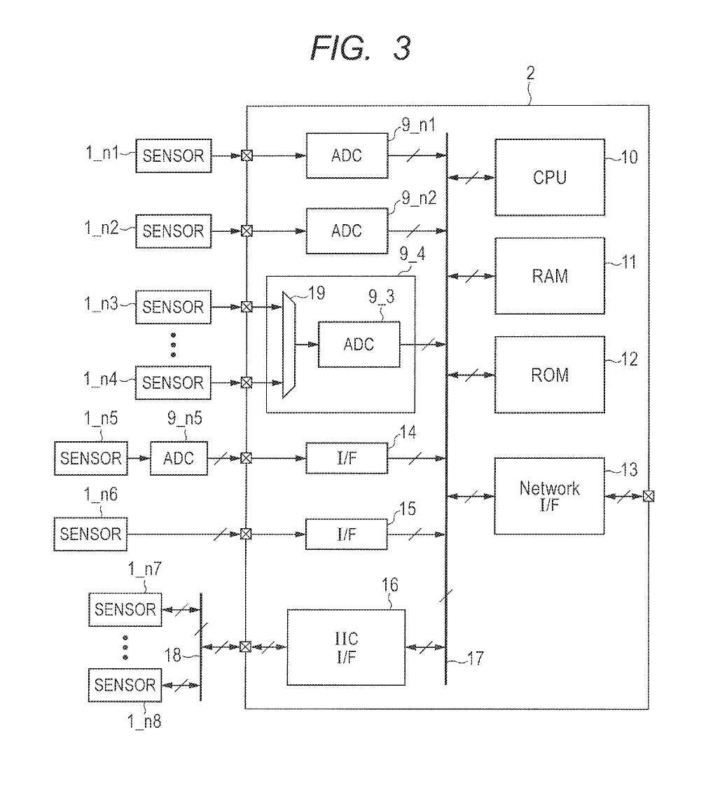

FIG. 3 is a block diagram showing an example hardware configuration of a semiconductor device 2 according to an embodiment of the present invention. The semiconductor device 2 is formed, for example, as a single-chip microcontroller, on a semiconductor substrate formed of, for example, but not limited to, monocrystalline silicon using semiconductor manufacturing technology such as CMOS (Complementary Metal-Oxide-Semiconductor) technology.

The semiconductor device 2 includes a CPU (Central Processing Unit) 10, a RAM (Random Access Memory) 11, a ROM (Read Only Memory) 12, a network interface 13, plural A/D (Analog to Digital) converters 9_n1, 9_n2, 9_4, and plural interfaces 14 to 16. The semiconductor device 2 has an internal bus 17 and can access the above function blocks from the CPU 10 via the bus 17. The bus 17 and memories such as RAM 11 and ROM 12 may be hierarchically configured.

The semiconductor sensor 2 can be coupled with plural sensors 1_n1, 1_n2, 1_n3 to 1_n4, 1_n5, 1_n6, 1_n7 to 1_n8. Sensors 1_n1 and 1_n2 output analog signals and are coupled to A/D converters 9_n1 and 9_n2, respectively. The A/D converter 9_4 includes an A/D converter 9_3 and a multiplexer 19 and converts, by time division, plural analog signals into digital data. The sensors 1_n3 to 1_n4 are coupled to the A/D converter 9_3 via the multiplexer 19. The signal from sensor 1_n5 is converted into digital data via the A/D converter 9_n5 externally attached to the semiconductor device 2 and is then inputted to the interface 14. The sensor 1_n6 outputs digital sensor-sensed data. The digital data outputted is inputted to the interface 15. The sensors 1_n7 to 1_n8 are coupled to the IIC interface 16, for example, via the IIC communication bus 18. The “IIC” stands for “Inter-Integrated Circuit” and is also denoted as I2C. The IIC is a bus specification proposed for serial communications between ICs (Integrated Circuits), for example, between a processor and peripheral devices.

In FIG. 3 showing the semiconductor device 2, various forms of coupling between the semiconductor device 2 and sensors are illustrated as examples, but the forms of coupling between the semiconductor device 2 and sensors are optional and the configuration of the semiconductor device is modified according to the adopted forms of coupling between the semiconductor device 2 and sensors.

The specific information extraction circuits 3_1 to 3_n, sensor information processing circuit 4, combined information generation unit 5, and uniquification processing unit 6 are realized, for example, by executing programs stored in the ROM 12. All or part of these functions may be mounted by means of special hardware different from the CPU 10. The uniquified information holding unit 7 is secured as a part of the storage area of the ROM 12 that is mounted as an electrically rewritable non-volatile memory.

As described above, sensor authentication processing can be performed by the semiconductor device 2 realized as a single-chip microcontroller.

The sensor authentication processing need not necessarily be performed, as described above, within a microcontroller.

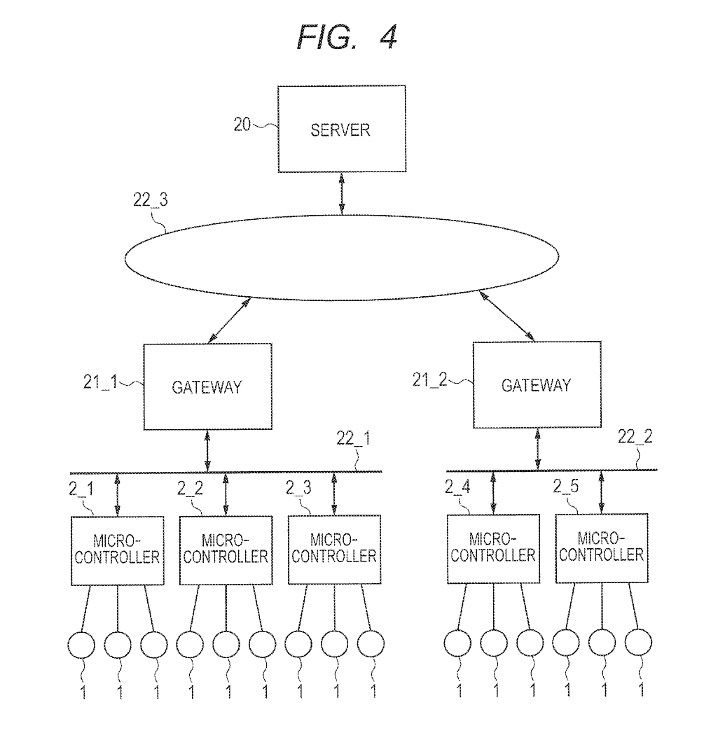

FIG. 4 is a block diagram schematically showing an example configuration of a data processing device according to an embodiment of the present invention. Microcontrollers 2_1 to 2_3 each coupled with plural sensors 1 are coupled to a gateway 21_1 via a network 22_1. Microcontrollers 2_4 to 2_5 each coupled with plural sensors 1 are coupled to a gateway 21_2 via a network 22_2. The gateways 21_1 and 21_2 are coupled to a server 20 via a higher-order network 22_3.

The specific information extraction circuits 3_1 to 3_n, sensor information processing circuit 4, combined information generation unit 5, and uniquification processing unit 6 may be realized as functions of the gateways 21_1 and 21_2 or as functions of the server 20 instead of being realized as functions of software incorporated in each of microcontrollers 2_1 to 2_5 described above. Also, they may be realized in a distributed manner in the microcontrollers 2_1 to 2_5, gateways 21_1 to 21_2, and server 20. For example, the registration information generated from the combined information combining the specific information about plural sensors may be managed in a unified manner to the server 20 and may be supplied, when authentication processing is to be performed, to the microcontroller or gateway to perform the authentication processing.

The server 20 may be, for example, a service layer of cloud computing or a data center of an IT system. Also, the networks 21_1 to 21_3 may be wired networks, wireless networks or the Internet.

Next, management of the registration information will be described. The registration information is the registered sensor information about the sensors coupled to the semiconductor device 2 and ensured to be authentic and in normal condition in an initial state, i.e. at the time of registration. During subsequent operation of the sensors, sensor monitoring (sensor authentication) is carried out at appropriate intervals. When an additional sensor is coupled to the semiconductor device 2 or any sensor is replaced, the registration information is re-generated and re-registered.

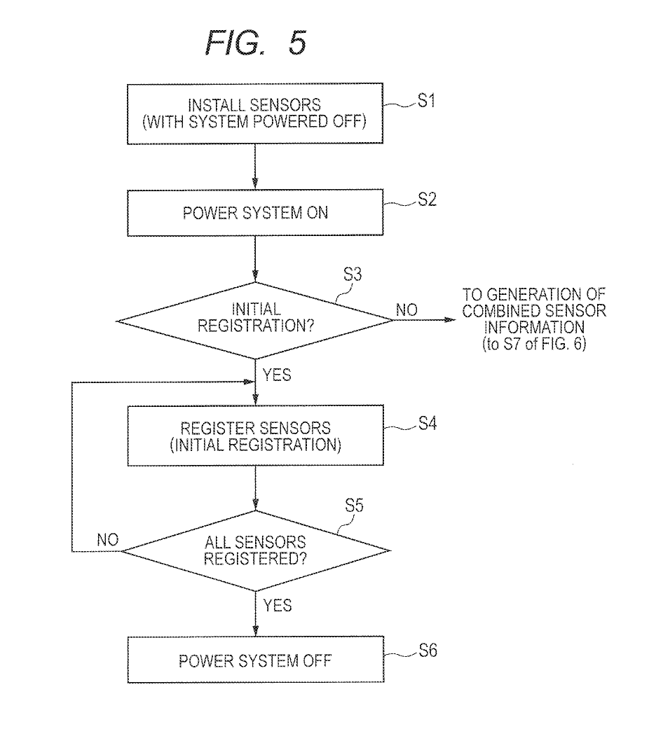

FIG. 5 is a flowchart showing an example of processing for initially registering sensor information in a semiconductor device or data processing device. The semiconductor device is, for example, a microcontroller 2 shown in FIG. 4 and the data processing device is, for example, the gateway 21_1 or 21_2 or the server 20.

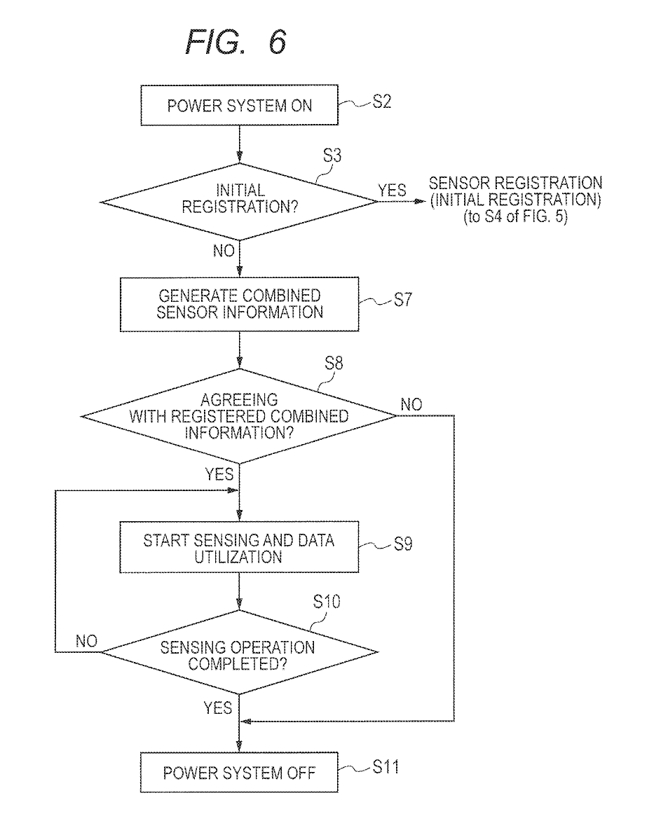

In a state with the system powered off, a sensor is newly installed (S1). At this time, all sensors coupled to the system are ensured to be authentic and operating in normal condition. When the system is powered on (S2), whether initial registration is to be carried out is determined (S3). For example, when there is no sensor data registered in the microcontroller 2, it is determined that initial registration is to be carried out. In this case, processing advances to carry out initial sensor registration (S4) to be repeated until all sensors have been registered. When all sensors have been registered (S5), the system is powered off to end processing (S6). When it is determined in S3 that initial registration is not to be carried out, processing advances to S7 shown in FIG. 6.

FIG. 6 is a flowchart showing an example of sensor authentication processing performed in a semiconductor device or data processing device. While the system is in operation, sensor monitoring (authentication processing) is carried out at appropriate intervals. When the system is powered on (S2), whether initial registration is to be carried out is determined (S3). As in the case shown in FIG. 5, when there is no sensor data registered in the microcontroller 2, it is determined that initial registration is to be carried out. In this case, processing advances to S4 shown in FIG. 5. When it is determined that initial registration is not to be carried out, processing advances to generate combined sensor information (S7). Next, whether the generated combined information agrees with the registered combined information is determined (S8). When the generated combined information agrees with the registered combined information, sensing operation by the sensors and sensed data utilization is started (S9). When sensing operation is completed (S10: Y), the system is powered off (S11). When, in S8, it is determined that the generated combined information does not agree with the registered combined information (S8: N), sensed data utilization is not started and the system is immediately powered off (S11). At this time, additional steps may be taken before powering the system off, for example, to report abnormality or to issue warning or an alarm.

In the example processing shown in FIG. 6, sensor authentication processing is performed when the system is powered on (S2), but, in an alternative configuration, when to perform sensor authentication processing may be determined according to a status flag provided to be controlled, for example, by a timer.

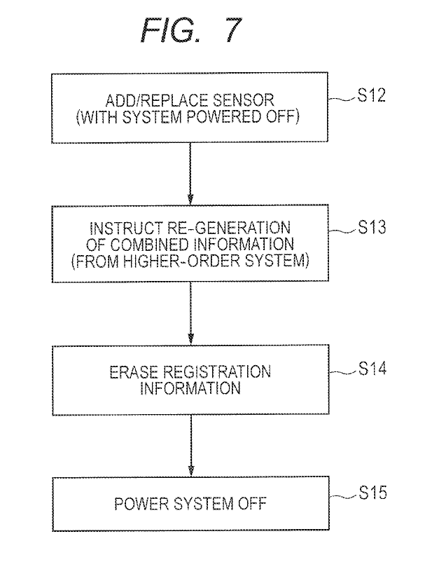

FIG. 7 is a flowchart showing an example of processing performed in a semiconductor device or data processing device after addition or replacement of a sensor. Addition or replacement of a sensor is carried out with the system powered off (S12). After a sensor is added or replaced, the system is powered on and re-generation of combined information is instructed from a higher-order system (S13). Since it is required that the additional or replacement sensor is ensured to be authentic, the instruction for re-generating combined information is preferably inputted from a higher-order system by a system manager. While, in response to the instruction, combined information is re-generated, the existing registration information is erased (S14). Subsequently, the system is powered off (S15) to end processing.

### Third Embodiment

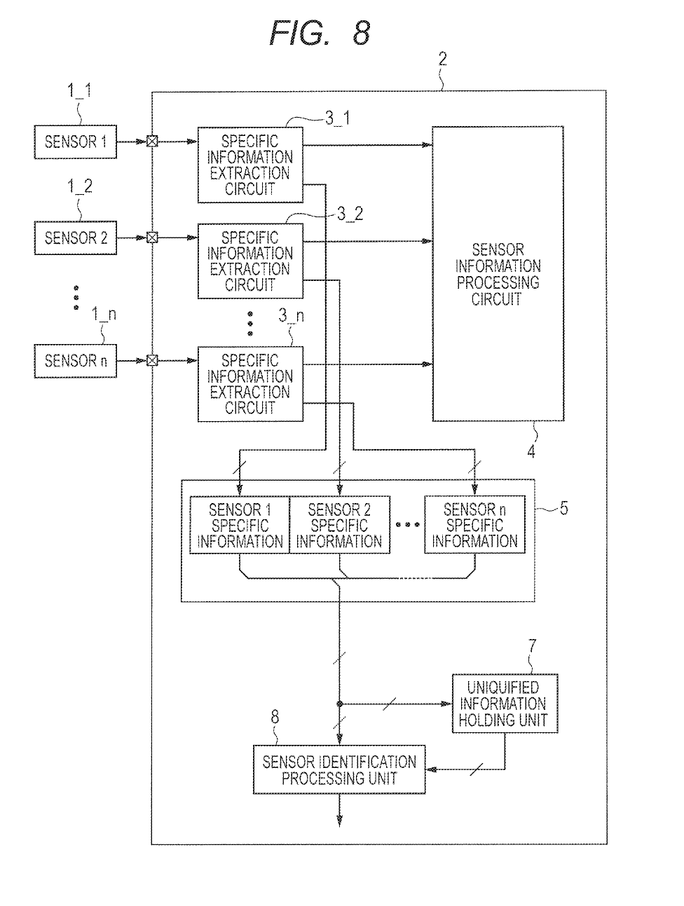

FIG. 8 is a block diagram schematically showing an example configuration of a semiconductor device according to another embodiment of the present invention. The configuration shown in FIG. 8 is similar to the configuration shown in FIG. 1, but the uniquification processing 6 is not included in the configuration shown in FIG. 8. When combined information is generated, the generated information is stored as it is in the uniquified information holding unit 7 to be held therein as registration information. For authentication processing, combined information generated in the combined information generation unit 5 is supplied as it is to the sensor authentication processing unit 8 and is compared with the registration information held in the uniquified information holding unit 7. When the result of the comparison is a match, sensing by the sensors is started in a normal manner. When the result of the comparison is a non-match, input to the sensor information processing circuit 4 of the information sensed by the sensor that has caused the comparison result to be a non-match is blocked. Or, use of the information sensed by the sensor is stopped in the sensor information processing circuit 4.

In this configuration without the uniquification processing unit 6, the combined information is used as it is for sensor authentication processing without involving irreversible compression. Therefore, the uniquified information holding unit 7 is required to have a large storage capacity. An advantage of this configuration is that, by isolating the sensor having caused the result of the comparison to be a non-match, sensing by the other sensors can be continued. The isolated sensor may be a fake sensor or may be out of order.

When the sensor having caused the comparison result to be a non-match is identified, the semiconductor device (e.g. microcontroller 2) or the data processing device (e.g. gateway 21_1, 21_2 or server 20) higher-leveled than the semiconductor device can issue an alarm to urge the system manager or the user to replace or repair the sensor.

The invention made by the present inventors has been specifically described based on embodiments, but the invention is not limited to the embodiments and can be modified in various ways without departing from the scope of the invention.

For example, the sensors may be changed to other electronic parts. Also, the microcontroller referred to as an exemplary semiconductor device may be changed to a processor of a different architecture.

What is claimed is:

1. A semiconductor device that can be electrically coupled with a plurality of sensors, the semiconductor device being capable of determining, by comparing registration information generated based on the sensors coupled to the semiconductor device when making registration and determination target information generated based on information obtained from the sensors coupled to the semiconductor device when making determination, that not all the sensors coupled to the semiconductor device at the time of the determination are authentic and in normal condition,
wherein the registration information is generated based on first combined information including a plurality of combined pieces of first information, the first information being specific about the respective sensors coupled to the semiconductor device at the time of the registration, and
wherein the determination target information is generated based on second combined information including a plurality of combined pieces of second information, the second information being specific about the respective sensors coupled to the semiconductor device at the time of the determination.

2. The semiconductor device according to claim 1,
wherein the registration information is information generated by irreversibly compressing the first combined information, and
wherein the semiconductor device generates the determination target information by irreversibly compressing the second combined information in a same manner as used when generating the registration information.

3. The semiconductor device according to claim 2,
wherein the irreversible compression uses a hash function.

4. The semiconductor device according to claim 1,
wherein at least either the plurality of pieces of first information or the plurality of pieces of second information are trimming data for the corresponding sensors.

5. The semiconductor device according to claim 1, comprising an analog/digital conversion circuit,
wherein at least either the plurality of pieces of first information or the plurality of pieces of second information are information included in analog signals outputted from the corresponding sensors, and
wherein the semiconductor device converts, at the time of the determination, the analog signals into digital values using the analog/digital conversion circuit and extracts, from results of the conversion, the second information.

6. The semiconductor device according to claim 1,
wherein the registration information is the first combined information, and
wherein the semiconductor device uses the second combined information as it is as the determination target information and, when a non-match is detected as a result of comparison between the registration information and the determination target information, ignores the information subsequently outputted from the sensor that outputted the second information that caused the non-match.

7. The semiconductor device according to claim 1,
wherein the plurality of pieces of first information and the plurality of pieces of second information are information included in digital data outputted from the corresponding sensors.

8. A data processing device capable of communicating with a plurality of sensors,
wherein, when making registration, the data processing device generates registration information based on first combined information, the first combined information including a plurality of combined pieces of first information, the first information being specific about the respective sensors coupled to the data processing device, and stores the generated registration information, and
wherein, when making determination, the data processing device compares determination target information generated based on second combined information, the second combined information including a plurality of combined pieces of second information, the second information being specific about the respective sensors coupled to the data processing device, with the stored registration information and, when the result of the comparison is a non-match, determines that not all the sensors coupled to the data processing device are authentic and in normal condition.

9. The data processing device according to claim 8,
wherein the registration information is information generated by irreversibly compressing the first combined information, and
wherein the data processing device generates the determination target information by irreversibly compressing the second combined information in a same manner as used when generating the registration information.

10. The data processing device according to claim 9,
wherein the irreversible compression uses a hash function.

11. The data processing device according to claim 8,
wherein at least either the plurality of pieces of first information or the plurality of pieces of second information are trimming data for the corresponding sensors.

12. The data processing device according to claim 8,
wherein the registration information is the first combined information, and
wherein the data processing device uses the second combined information as it is as the determination target information and, when a non-match is detected as a result of comparison between the registration information and the determination target information, ignores the information subsequently outputted from the sensor that outputted the second information that caused the non-match.

13. An authentication method performed using a data processing device capable of communicating with a plurality of sensors or using a semiconductor device that can be coupled with a plurality of sensors, the method being for determining whether the sensors are authentic,
wherein, when making registration, registration information is generated based on first combined information, the first combined information including a plurality of combined pieces of first information, the first information being specific about the respective sensors coupled to the data processing device or the semiconductor device and the generated registration information is stored in the data processing device, and
wherein, when making determination, determination target information is generated based on second combined information, the second combined information including a plurality of combined pieces of second information, the second information being specific about the respective sensors coupled to the data processing device or the semiconductor device, the generated determination target information is compared with the stored registration information, and, when the result of the comparison is a non-match, it is determined that not all the sensors coupled to the data processing device or the semiconductor device are authentic and in normal condition.

14. The authentication method according to claim 13,
wherein the registration information is information generated by irreversibly compressing the first combined information, and
wherein the data processing device or the semiconductor device generates the determination target information by irreversibly compressing the second combined information in a same manner as used when generating the registration information.

15. The authentication method according to claim 14,
wherein the irreversible compression uses a hash function.

16. The authentication method according to claim 13,
wherein at least either the plurality of pieces of first information or the plurality of pieces of second information are trimming data for the corresponding sensors.

17. The authentication method according to claim 13,
wherein the registration information is the first combined information, and
wherein the data processing device or the semiconductor device uses the second combined information as it is as the determination target information and, when a non-match is detected as a result of comparison between the registration information and the determination target information, ignores the information subsequently outputted from the sensor that outputted the second information that caused the non-match.
